(19) United States
(12) Patent Application Publication
(10) Pub. No.: US 2016/0006661 A1
(43) Pub. Date: Jan. 7, 2016

(54) TRAFFIC CLASSIFICATION METHODS, AND APPARATUSES USING THE SAME

(71) Applicant: Acer Incorporated, New Taipei City (TW)

(72) Inventor: Hung-Yu WEI, New Taipei City (TW)

(21) Appl. No.: 14/603,606

(22) Filed: Jan. 23, 2015

Related U.S. Application Data
(60) Provisional application No. 62/019,994, filed on Jul. 2, 2014.

(51) Int. Cl. H04L 12/851; H04W 52/02

(52) U.S. Cl. CPC H04L 47/2483; H04W 52/0222

(57) ABSTRACT

A mobile communication device including a wireless communication circuitry and a controller is provided. The wireless communication circuitry performs wireless transmission and reception to and from a service network. The controller determines a radio state of the mobile communication device when detecting an incoming data packet of a traffic flow from the service network via the wireless communication circuitry, determines whether the traffic flow is desirable or undesirable according to the radio state, and transmits the determination result to a traffic node of the service network via the wireless communication circuitry, so that subsequent data packets of the undesirable traffic flow, which are to be sent to the mobile communication device, are blocked or deferred at the service network, or subsequent data packets of the desirable traffic flow, which are to be sent to the mobile communication device, are prioritized or not blocked at the service network.

### CROSS REFERENCE TO RELATED APPLICATIONS

This Application claims priority of U.S. Provisional Application No. 62/019,994, filed on Jul. 2, 2014, the entirety of which is incorporated by reference herein.

### BACKGROUND OF THE INVENTION

1. Field of the Invention

The invention generally relates to traffic classification, and more particularly, to methods and apparatuses for classifying traffic flows according to the radio state of the mobile communication device.

2. Description of the Related Art

With growing demand for ubiquitous computing and networking, various wireless technologies have been developed, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, and Time-Division LTE (TD-LTE) technology. By employing one of the wireless technologies, a mobile communication device may wirelessly connect to a service network for accessing Internet or obtaining data services anytime and anywhere.

However, when connecting to any service network, the mobile communication device is generally assigned with a private or public Internet Protocol (IP) address and is reachable through the IP address, thereby causing the mobile communication device to become a potential target for malicious attacks, such as port scanning attacks, Denial of Service (DoS) flooding attacks, and battery draining attacks. Conventionally, a manual configuration method may be employed in which a user has to rely on his/her own judgment to identify which of the traffic flows are malicious and which of them are safe, but the configuration process is time-consuming and inaccurate especially with a large number of traffic flows.

Alternatively, an autonomous classification method may be employed in which each traffic flow is analyzed and classified according to one or more of its attributes, such as the application type, protocol type, data rate, source IP address, source port number, destination IP address, destination port number, etc. Nonetheless, with the rapid development of mobile communications, the traffic types of mobile applications are dramatically different from conventional voice traffic. For example, many mobile applications not only create a large number of data packets during active sessions, but also create background traffic to constantly query or update the application, which inevitably increases power consumption by the mobile communication device. As a result, only taking the attributes of traffic flows into account may not provide a flexible and energy-efficient solution for traffic classification.

### BRIEF SUMMARY OF THE INVENTION

In order to solve the aforementioned problem, the invention proposes to classify traffic flows according to the radio state of the mobile communication device, so as to identify which traffic flows are undesirable and which are desirable. Specifically, undesirable traffic flows may include traffic flows which cause energy-inefficient operation of the mobile communication device, as well as traffic flows that are suspicious (e.g., they are possibly related to battery draining attacks). Desirable traffic flows may include traffic flows which do not cause energy-inefficient operation of the mobile communication device, as well as traffic flows which indicate a request-response traffic pattern, or those that are possibly associated with user interaction with the mobile communication device.

In the first aspect of the invention, a mobile communication device is provided. The mobile communication device comprises a wireless communication circuitry and a controller. The wireless communication circuitry is configured to perform wireless transmission and reception to and from a service network. The controller is configured to determine a radio state of the mobile communication device when detecting an incoming data packet of a traffic flow from the service network via the wireless communication circuitry, and determine whether the traffic flow is desirable or undesirable according to the radio state. Also, the controller is further configured to transmit the determination result of whether the traffic flow is desirable or undesirable to a traffic node of the service network via the wireless communication circuitry, so that one or more subsequent data packets of the undesirable traffic flow, which are to be sent to the mobile communication device, are blocked or deferred at the service network, or one or more subsequent data packets of the desirable traffic flow, which are to be sent to the mobile communication device, are prioritized or not blocked at the service network.

In the second aspect of the invention, a traffic classification method executed by a mobile communication device is provided. The traffic classification method comprises the steps of: determining a radio state of the mobile communication device when detecting an incoming data packet of a traffic flow from a service network; determining whether the traffic flow is desirable or undesirable according to the radio state; and transmitting the determination result of whether the traffic flow is desirable or undesirable to a traffic node of the service network, so that one or more subsequent data packets of the undesirable traffic flow, which are to be sent to the mobile communication device, are blocked or deferred at the service network, or one or more subsequent data packets of the desirable traffic flow, which are to be sent to the mobile communication device, are prioritized or not blocked at the service network.

In the third aspect of the invention, a traffic node of a service network is provided. The traffic node comprises a communication circuitry and a controller. The communication circuitry is configured to receive an incoming data packet of a traffic flow, which is to be sent to a mobile communication device. The controller is configured to determine a radio state of the mobile communication device when the incoming data packet of the traffic flow is received, and determine whether the traffic flow is desirable or undesirable according to the radio state. Also, the controller is further configured to block or defer the incoming data packet of the undesirable traffic flow when the traffic flow is determined to be undesirable, or prioritize or not block the incoming data packet of the traffic flow when the traffic flow is determined to be desirable.

In the fourth aspect of the invention, a traffic classification method executed by a traffic node of a service network is provided. The traffic classification method comprises the steps of: determining a radio state of a mobile communication device when receiving an incoming data packet of the traffic flow, which is to be sent to the mobile communication device; determining whether the traffic flow is desirable or undesirable according to the radio state; and blocking or deferring the incoming data packet of the undesirable traffic flow when the traffic flow is determined to be undesirable, or prioritizing or not blocking the incoming data packet of the traffic flow when the traffic flow is determined to be desirable.

Other aspects and features of the invention will become apparent to those with ordinary skill in the art upon review of the following descriptions of specific embodiments of the mobile communication devices, the traffic nodes, and the traffic classification methods thereof.

### BRIEF DESCRIPTION OF DRAWINGS

The invention can be more fully understood by reading the subsequent detailed description and examples with references made to the accompanying drawings, wherein:

FIG. 1 is a block diagram of a wireless communication environment according to an embodiment of the invention;

FIG. 2 is a block diagram illustrating the mobile communication device 110 according to an embodiment of the invention;

FIG. 3 is a block diagram illustrating a traffic node of the service network 120 according to an embodiment of the invention;

FIGS. 4A and 4B show a message sequence chart illustrating the traffic classification method according to an embodiment of the invention; and

FIG. 5 is a message sequence chart illustrating the traffic classification method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

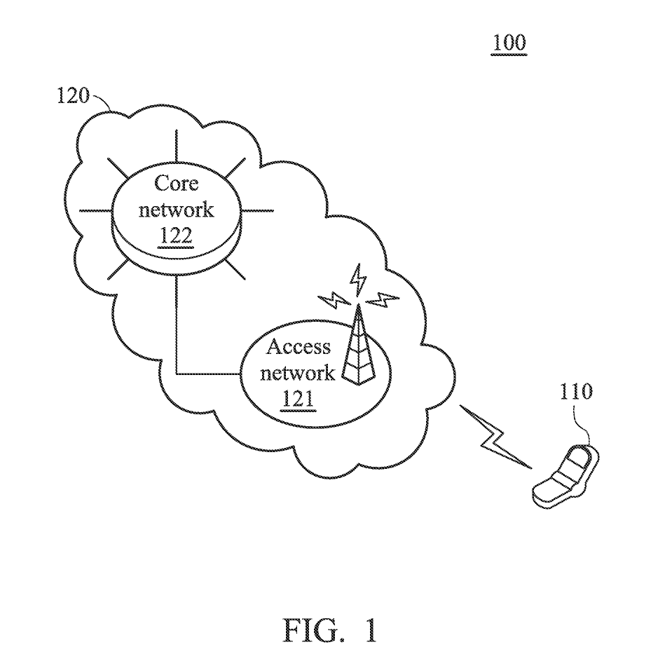

FIG. 1 is a block diagram of a wireless communication environment according to an embodiment of the invention. The wireless communication environment 100 comprises a mobile communication device 110 and a service network 120, wherein the mobile communication device 110 is wirelessly connected to the service network 120 for obtaining mobile services, including voice and/or data services. The mobile communication device 110 may be a feature phone, a smartphone, a panel Personal Computer (PC), a laptop computer, or any computing device supporting the wireless technology utilized by the service network 120. The service network 120 may be a 3rd Generation Partnership Project (3GPP) system, such as a GSM/GPRS/EDGE system, a WCDMA system, a CDMA-2000 system, a TD-SCDMA system, a WiMAX system, or an LTE/LTE-A/TD-LTE system.

Specifically, the service network 120 comprises an access network 121 and a core network 122, wherein the access network 121 is responsible for processing radio signals, terminating radio protocols, and connecting the mobile communication device 110 with the core network 122, while the core network 122 is responsible for performing mobility management, network-side authentication, and interfaces with public/external networks (e.g., the Internet). Each of the access network 121 and the core network 122 may comprise one or more network nodes for carrying out said functions. For example, if the service network 120 is a GSM/GPRS/EDGE/WCDMA system, the access network 121 may be a Base Station Subsystem (BSS) which includes at least a Base Transceiver Station (BTS) and a Base Station Controller (BSC), and the core network 122 may be a GPRS core which includes a Home Location Register (HLR), at least one Serving GPRS Support Node (SGSN), at least one Gateway GPRS Support Node (GGSN), and optionally a Policy and Charging Rules Function (PCRF) node. That is, each of the BTS, BSC, HLR, SGSN, GGSN, and PCRF node may be referred to as a network node of the service network 120, wherein the BTS, BSC, SGSN, and GGSN that specifically participate in delivering data packets of traffic flows may be referred to as traffic nodes. Each of the traffic nodes may be installed with a firewall module/device for monitoring the incoming and outgoing data packets and filtering off the undesirable (e.g., malicious, suspicious, or questionable) ones.

Alternatively, if the service network 120 is an LTE/LTE-A/TD-LTE system, the access network 121 may be an Evolved-UTRAN (E-UTRAN) which includes at least an evolved NB (eNB) (e.g., a home eNB, macro BS, or pico BS), and the core network 122 may be an Evolved Packet Core (EPC) which includes a Home Subscriber Server (HSS), Mobility Management Entity (MME), Serving Gateway (S-GW), Packet Data Network Gateway (PDN-GW or P-GW), and optionally a PCRF node. That is, each of the eNB, HSS, MME, S-GW, PDN-GW/P-GW, and PCRF node may be referred to as a network node of the service network 120, wherein the eNB, HSS, S-GW, and PDN-GW/P-GW that specifically participate in delivering data packets of traffic flows may further be referred to as traffic nodes. Each of the traffic nodes may be installed with a firewall module/device for monitoring the incoming and outgoing data packets and filtering off the undesirable (e.g., malicious, suspicious, or questionable) ones.

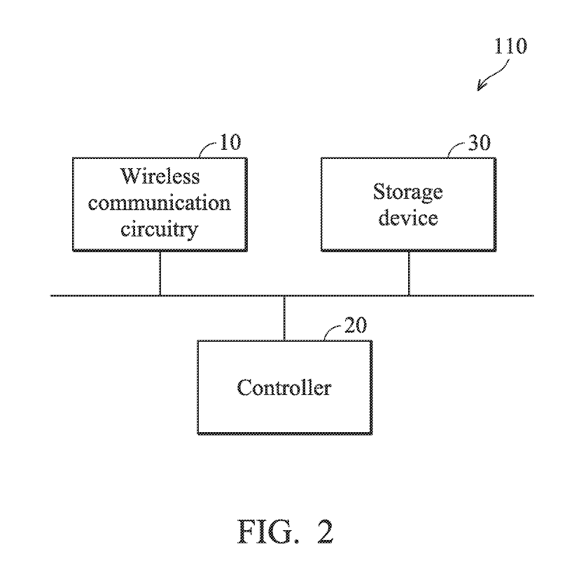

FIG. 2 is a block diagram illustrating the mobile communication device 110 according to an embodiment of the invention. A mobile communication device 110 comprises a wireless communication circuitry 10, a controller 20, and a storage device 30. The wireless communication circuitry 10 is responsible for performing the functionality of wireless transmission and reception to and from the service network 120. For example, the wireless communication circuitry 10 may comprise an antenna, a Radio Frequency (RF) device, and a baseband chip. The baseband chip performs baseband signal processing, including Analog-to-Digital Conversion (ADC)/Digital-to-Analog Conversion (DAC), gain adjusting, modulation/demodulation, encoding/decoding, and so on. The RF device receives RF wireless signals via the antenna, converts the received RF wireless signals to baseband signals, which are processed by the baseband chip, or receives baseband signals from the baseband chip and converts the received baseband signals to RF wireless signals, which are later transmitted via the antenna. The operative radio frequency may be 900 MHz, 1800 MHz, or 1900 MHz utilized in the GPRS/GPRS/EDGE technology, or 900 MHz, 1900 MHz, or 2100 MHz utilized in WCDMA technology, or 900 MHz, 2100 MHz, or 2.6 GHz utilized in LTE/LTE-A/TD-LTE technology, or other radio frequencies depending on the wireless technology in use.

The controller 20 may be a general-purpose processor, a Micro-Control Unit (MCU), an application processor, a Digital Signal Processor (DSP), or the like, which provides the function of data processing and computing, and controls the operation of the wireless communication circuitry 10, and loads and executes a series of instructions and/or program codes from the storage device 30 to perform the traffic classification method of the present application.

The storage device 30 may be a memory (e.g., Random Access Memory (RAM), Flash memory, or Non-Volatile Random Access Memory (NVRAM), etc.), a magnetic storage device (e.g., magnetic tape or hard disk), an optical storage device (e.g., Compact Disc Read-Only Memory (CD-ROM)), or any combination thereof for storing instructions and/or program codes of applications and/or communication protocols, buffering incoming and/or outgoing data packets, the radio state of the mobile communication device 110, and the classification rules or management policies.

Although not shown, the mobile communication device 110 may further comprise other functional units, such as an Input/Output (I/O) device (e.g., display device, button, keyboard, mouse, touch pad, touch screen, etc.), a power supply, and a firewall module/device for filtering off undesirable data packets, etc., and the invention is not limited thereto.

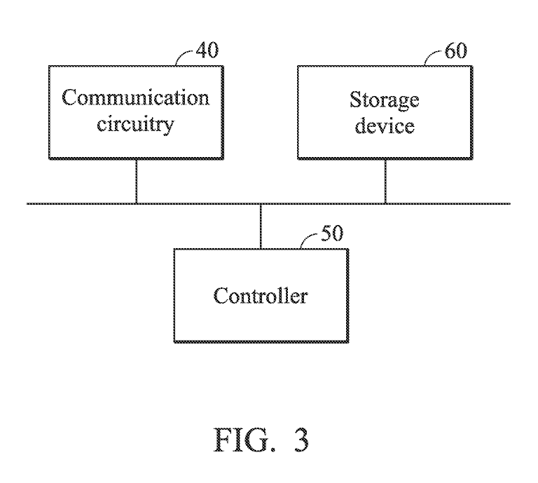

FIG. 3 is a block diagram illustrating a traffic node of the service network 120 according to an embodiment of the invention. The traffic node comprises a communication circuitry 40, a controller 50, and a storage device 60. The communication circuitry 40 is responsible for performing the functionality of wired and/or wireless communications. For example, if the communication circuitry 40 supports the function of wired communication, it may comprise a cable modem, an Asymmetric Digital Subscriber Line (ADSL) modem, a Fiber-Optic Modem (FOM), an Ethernet network interface, or another wired interface. If the communication circuitry 40 supports the function of wireless communication, it may comprise an antenna, an RF device, and a baseband chip. The detailed description of the antenna, RF device, and baseband chip is similar to the wireless communication circuitry 10 described above, and thus, is not repeated here for brevity.

The controller 50 may be a general-purpose processor, an MCU, an application processor, a DSP, or the like, which provides the function of data processing and computing, and controls the operation of the communication circuitry 40, and loads and executes a series of instructions and/or program codes from the storage device 60 to perform the traffic classification method of the present application.

The storage device 60 may be a memory (e.g., RAM, Flash memory, or NVRAM, etc.), a magnetic storage device (e.g., magnetic tape or hard disk), an optical storage device (e.g., CD-ROM), or any combination thereof for storing instructions and/or program codes of applications and/or communication protocols, and buffering incoming and/or outgoing data packets that are meant for the mobile communication device 110, the radio state of the mobile communication device 110, and the classification rules or management policies.

Although not shown, the traffic node may further comprise other functional units, such as an Input/Output (I/O) device (e.g., display device, button, keyboard, mouse, touch pad, touch screen, etc.), a power supply, and a firewall module/device for filtering off undesirable data packets, etc., and the invention is not limited thereto.

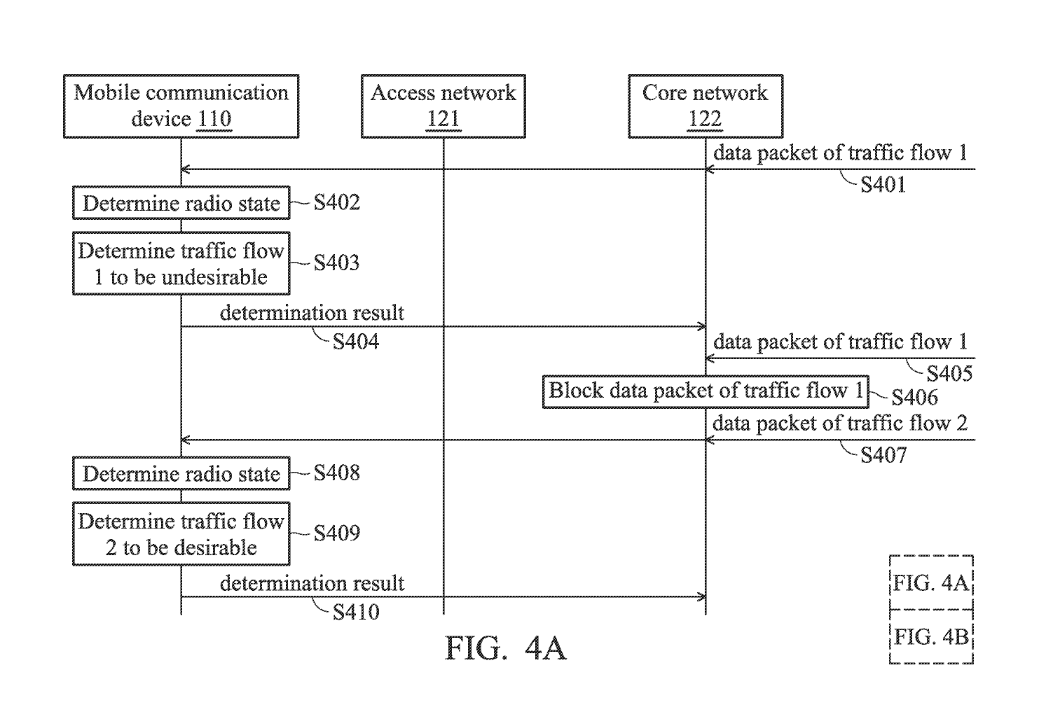

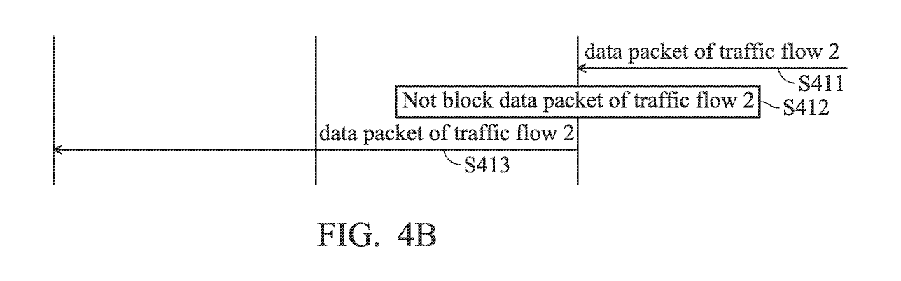

FIGS. 4A and 4B show a message sequence chart illustrating the traffic classification method according to an embodiment of the invention. To begin, the mobile communication device 110 receives an incoming data packet of a traffic flow (denoted as traffic flow 1 in FIG. 4A) from the service network 120 (step S401). Next, the mobile communication device 110 determines its current radio state (step S402). Specifically, the radio state indicates whether the mobile communication device 110 operates in the energy-saving state or non-energy-saving state, wherein the energy-saving state may be the RRC (Radio Resource Control)_IDLE state, DRX (Discontinuous Reception)_OFF state, ECM (EPS (Evolved Packet System) Connection Management)_IDLE state, or MME (Mobility Management Entity)_DEREGISTERED state as defined in 3rd Generation Partnership Project (3GPP) specifications, and the non-energy-saving state may be the RRC_CONNECTED state, DRX_ON state, ECM_CONNECTED state, or MME_REGISTERED state as defined in the 3GPP specifications. Alternatively, the energy-saving state may be a state (e.g., a do-not-disturb state) defined by the user, which indicates that the mobile communication device 110 does not wish to receive any incoming packet of all traffic flows or low-priority traffic flows. For example, background traffic flows may be considered as low-priority traffic flows, while voice traffic flows may be considered as high-priority traffic flows.

Due to the current radio state being an energy-saving state or the mobile communication device 110 being about to switch from operating in the non-energy-saving state to operating in the energy-saving state (e.g., the Inactivity timer for the mobile communication device 110 is close to expiring), the mobile communication device 110 determines the traffic flow to be undesirable (step S403), and then transmits the determination result to a gateway device in the core network 122 (i.e., an ingress traffic node of the service network 120) (step S404). Specifically, the gateway device may be a GGSN if the service network 120 is a GSM/GPRS/EDGE/WCDMA system, or may be an S-GW or P-GW if the service network 120 is an LTE/LTE-A/TD-LTE system. In one embodiment, the gateway device may be installed with a firewall module/device, and the determination result may serve as a classification rule for a firewall. In another embodiment, the gateway device may not be installed with a firewall module/device, and the determination result may serve as a management policy (e.g., scheduling policy, deferring policy, or paging policy).

In another embodiment, a traffic flow may be determined to be undesirable if the number of incoming data packets, received when the mobile communication device operates in the energy-saving state, has reached to a predetermined threshold. For example, if more than 4 out of every 10 data packets are received in the energy-saving state, the associated traffic flow is determined to be undesirable.

In yet another embodiment, a probabilistic distribution function (e.g., Cumulative Distribution Function (CDF)) of the Inactivity timer (e.g., the timer setting or the residual timer value) when receiving an incoming data packet may be used to determine whether a traffic flow is desirable or undesirable. For example, assuming that the mobile communication device 110 operates in the non-energy-saving state 70% of the time and operates in the energy-saving state 30% of the time, then a traffic flow may be determined to be undesirable if 10% of the data packets arrive when the mobile communication device 110 operates in the non-energy-saving state and 90% of the data packets arrive when the mobile communication device 110 operates in the energy-saving state.

In still another embodiment, a cost function (e.g., summation of cost, moving average of cost, standard deviation of cost, increasing/decreasing trend of cost, randomness measure of cost, time-dependent correlation of cost, or moment generating function) of expected power consumption needed to handle the incoming data packet under a certain radio state may be used to determine whether a traffic flow is desirable or undesirable.

Subsequent to step S404, the gateway device in the core network 122 processes subsequent data packets of the traffic flow 1 according to the determination result. Specifically, the gateway device in the core network 122 receives another incoming data packet of the traffic flow 1, which is to be sent to the mobile communication device 110 (step S405), and then blocks the incoming data packet since the traffic flow 1 is determined to be undesirable (step S406). That is, subsequent data packets of the traffic flow 1 will be blocked at the gateway device in the core network 122 and will not be sent to the mobile communication device 110, thereby reducing power consumption of the mobile communication device 110. In other words, the mobile communication device 110 may be able to stay in the energy-saving state without being interrupted by the undesirable traffic flow.

In another embodiment, the gateway device in the core network 122 may defer, instead of blocking, the incoming data packet of the traffic flow 1 in step S406. For example, the gateway device in the core network 122 may buffer the incoming data packet of the traffic flow 1 and send it to the mobile communication device 110 when the radio state of the mobile communication device 110 has switched from the energy-saving state to the non-energy-saving state.

Subsequent to step S406, the mobile communication device 110 receives an incoming data packet of another traffic flow (denoted as traffic flow 2 in FIG. 4A) from the service network 120 (step S407). Next, the mobile communication device 110 determines its current radio state (step S408). Due to the current radio state being a non-energy-saving state or the mobile communication device 110 being about to switch from operating in the energy-saving state to operating in the non-energy-saving state, the mobile communication device 110 determines the traffic flow to be desirable (step S409), and then transmits the determination result to the gateway device in the core network 122 (step S410).

That is, the radio state of the mobile communication device 110 is the energy-saving state when the mobile communication device 110 receives the incoming data packet of the traffic flow 1 in step S401, and then it changes to the non-energy-saving state when the mobile communication device 110 receives the incoming data packet of the traffic flow 2 in step S407.

In response to receiving the determination result, the gateway device in the core network 122 processes subsequent data packets of the traffic flow 2 according to the determination result. Specifically, the gateway device in the core network 122 receives another incoming data packet of the traffic flow 2, which is to be sent to the mobile communication device 110 (step S411), and then does not block the incoming data packet since the traffic flow 2 is determined to be desirable (step S412). That is, the incoming data packet of the traffic flow 2 is not blocked at the gateway device in the core network 122 and is sent to the mobile communication device 110 (step S413).

In another embodiment, the gateway device in the core network 122 may prioritize, instead of just not blocking, the incoming data packet of the traffic flow 2 in step S412. For example, the gateway device in the core network 122 may prioritize the data packets of the traffic flow 2 over the data packets of other traffic flows, i.e., the data packet of the traffic flow 2 will be the first to be sent to the mobile communication device 110 if data packets of multiple traffic flows arrive in the gateway device at roughly the same time.

It should be understood that the gateway device in the embodiment of FIGS. 4A and 4B is merely an illustrative example, and another traffic node (e.g., BTS, BSC, SGSN, or PCRF node of a GSM/GPRS/EDGE/WCDMA system, or eNB or MME of an LTE/LTE-A/TD-LTE system) of the service network 120 may be employed instead to apply the classification rules or management policies for processing the traffic flows for the mobile communication device 110.

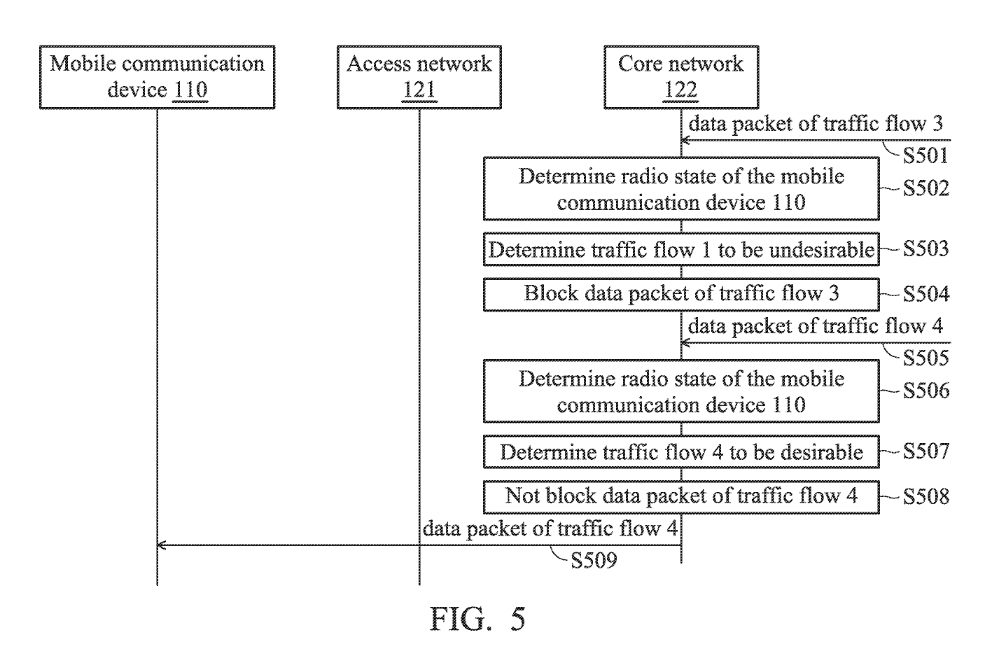

FIG. 5 is a message sequence chart illustrating the traffic classification method according to another embodiment of the invention. In this embodiment, the traffic classification method is executed by a gateway device in the core network 122. To begin, the gateway device in the core network 122 receives an incoming data packet of a traffic flow (denoted as traffic flow 3 in FIG. 5), which is be sent to the mobile communication device 110 (step S501). Next, the gateway device in the core network 122 determines the current radio state of the mobile communication device 110 (step S502). The gateway device in the core network 122 may retrieve the radio state of the mobile communication device 110 from another traffic node (e.g., MME or eNB) of the service network 120, or the mobile communication device 110 may report its radio state to the gateway device in the core network 122. The detailed description of the radio state is similar to the embodiment of FIGS. 4A and 4B as described above, and thus, is not repeated here for brevity. Due to the current radio state being an energy-saving state or the mobile communication device 110 being about to switch from operating in the non-energy-saving state to operating in the energy-saving state (e.g., Inactivity timer for the mobile communication device 110 is close to expiring), the gateway device in the core network 122 determines the traffic flow 3 to be undesirable (step S503), and then blocks the incoming data packet of the traffic flow 3 (step S504). That is, the data packets of the traffic flow 3 will be blocked at the gateway device in the core network 122 and will not be sent to the mobile communication device 110, thereby reducing power consumption of the mobile communication device 110. In other words, the mobile communication device 110 may be able to stay in the energy-saving state without being interrupted by the undesirable traffic flow.

Subsequently, the gateway device in the core network 122 receives an incoming data packet of another traffic flow (denoted as traffic flow 4 in FIG. 5), which is be sent to the mobile communication device 110 (step S505). Next, the gateway device in the core network 122 determines the current radio state of the mobile communication device 110 (step S506). Due to the current radio state being a non-energy-saving state or the mobile communication device 110 being about to switch from operating in the energy-saving state to operating in the non-energy-saving state, the gateway device in the core network 122 determines the traffic flow to be desirable (step S507), and then does not block the incoming data packet of the traffic flow 4 (step S508). That is, the incoming data packet of the traffic flow 4 is not blocked at the gateway device in the core network 122 and is sent to the mobile communication device 110 (step S509).

The determination results in steps S503 and S507 may serve as a classification rule for firewall (if the gateway device is installed with a firewall module/device), or as a management policy for the gateway device.

It should be understood that the gateway device in the embodiment of FIG. 5 is merely an illustrative example, and another traffic node (e.g., BTS, BSC, SGSN, or PCRF node of a GSM/GPRS/EDGE/WCDMA system, or eNB or MME of an LTE/LTE-A/TD-LTE system) of the service network 120 may be employed instead to perform the traffic classification and also to apply the classification rules or management policies for processing the traffic flows for the mobile communication device 110.

Alternatively, the gateway device may perform the traffic classification for generating the classification rules or management policies and then send them to another traffic node (e.g., BTS, BSC, SGSN, or PCRF node of a GSM/GPRS/EDGE/WCDMA system, or eNB or MME of an LTE/LTE-A/TD-LTE system) of the service network 120 for processing the traffic flows for the mobile communication device 110 according to the classification rules or management policies.

In addition to the radio state of the mobile communication device 110, the association between incoming data packets and outgoing data packets of the same traffic flow may be used to determine whether a traffic flow is desirable or undesirable. For example, if there are some outgoing data packets being transmitted within a time duration before receiving an incoming data packet, this may be an indication of the request-response traffic pattern, and thus, the traffic flow may be determined to be desirable. If there are some outgoing data packets being transmitted within a time duration after receiving an incoming data packet, the traffic flow may be determined to be desirable.

Moreover, the association between the incoming data packets and the user interaction with the mobile communication device 110 may also be used to determine whether a traffic flow is desirable or undesirable. For example, if user interaction with the mobile communication device 110 (e.g., a touch on the screen of the mobile communication device 110) is detected within a time duration after receiving an incoming data packet, the traffic flow may be determined to be desirable.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A mobile communication device, comprising:
a wireless communication circuitry, performing wireless transmission and reception to and from a service network; and
a controller, determining a radio state of the mobile communication device when detecting an incoming data packet of a traffic flow from the service network via the wireless communication circuitry, determining whether the traffic flow is desirable or undesirable according to the radio state, and transmitting the determination result of whether the traffic flow is desirable or undesirable to a traffic node of the service network via the wireless communication circuitry,
so that subsequent data packets of the undesirable traffic flow, which are to be sent to the mobile communication device, are blocked or deferred at the service network, or subsequent data packets of the desirable traffic flow, which are to be sent to the mobile communication device, are prioritized at the service network.

2. The mobile communication device of claim 1, wherein the controller further determines the traffic flow to be undesirable when the radio state indicates that the mobile communication device operates in an energy-saving state, or that the mobile communication device is about to switch from operating in a non-energy-saving state to operating in the energy-saving state.

3. The mobile communication device of claim 2, wherein the controller further determines the traffic flow to be desirable when the radio state indicates that the mobile communication device operates in the non-energy-saving state, or that the mobile communication device is about to switch from operating in the energy-saving state to operating in the non-energy-saving state.

4. The mobile communication device of claim 3, wherein the energy-saving state is one of the following:
an RRC (Radio Resource Control)_IDLE state;
a DRX (Discontinuous Reception)_OFF state;
an ECM (EPS (Evolved Packet System) Connection Management)_IDLE state; and
an MME (Mobility Management Entity)_DEREGISTERED state.

5. The mobile communication device of claim 3, wherein the non-energy-saving state is one of the following:
an RRC_CONNECTED state;
a DRX_ON state;
an ECM_CONNECTED state; and
an MME_REGISTERED state.

6. The mobile communication device of claim 1, wherein the controller further determines whether there is an outgoing data packet of the traffic flow being transmitted within a time duration before or after detecting the incoming data packet, and determines the traffic flow to be desirable when there is an outgoing data packet of the traffic flow being transmitted within the time duration before or after detecting the incoming data packet.

7. The mobile communication device of claim 1, wherein the controller further determines whether there is a user interaction with the mobile communication device within a time duration after detecting the incoming data packet, and determines the traffic flow to be desirable when there is a user interaction with the mobile communication device within the time duration after detecting the incoming packet data.

8. A traffic classification method executed by a mobile communication device, comprising:
determining a radio state of the mobile communication device when detecting an incoming data packet of a traffic flow from a service network;
determining whether the traffic flow is desirable or undesirable according to the radio state; and
transmitting the determination result of whether the traffic flow is desirable or undesirable to a traffic node of the service network, so that subsequent data packets of the undesirable traffic flow, which are to be sent to the mobile communication device, are blocked or deferred at the service network, or subsequent data packets of the desirable traffic flow, which are to be sent to the mobile communication device, are prioritized at the service network.

9. The traffic classification method of claim 8, further comprising:
determining the traffic flow to be undesirable when the radio state indicates that the mobile communication device operates in an energy-saving state, or that the mobile communication device is about to switch from operating in a non-energy-saving state to operating in the energy-saving state.

10. The traffic classification method of claim 9, further comprising:
determining the traffic flow to be desirable when the radio state indicates that the mobile communication device operates in a non-energy-saving state, or that the mobile communication device is about to switch from operating in an energy-saving state to operating in the non-energy-saving state.

11. The traffic classification method of claim 10, wherein the energy-saving state is one of the following:
an RRC (Radio Resource Control)_IDLE state;
a DRX (Discontinuous Reception)_OFF state;
an ECM (EPS (Evolved Packet System) Connection Management)_IDLE state; and
an MME (Mobility Management Entity)_DEREGISTERED state.

12. The traffic classification method of claim 10, wherein the non-energy-saving state is one of the following:
an RRC_CONNECTED state;
a DRX_ON state;
an ECM_CONNECTED state; and
an MME_REGISTERED state.

13. The traffic classification method of claim 8, further comprising:
determining whether there is an outgoing data packet of the traffic flow being transmitted within a time duration before or after detecting the incoming data packet; and
determining the traffic flow to be desirable when there is an outgoing data packet of the traffic flow being transmitted within the time duration before or after detecting the incoming data packet.

14. The traffic classification method of claim 8, further comprising:
determining whether there is a user interaction with the mobile communication device within a time duration after detecting the incoming data packet and
determining the traffic flow to be desirable when there is a user interaction with the mobile communication device within the time duration after detecting the incoming data packet.

15. A traffic node of a service network, comprising:
a communication circuitry, receiving an incoming data packet of a traffic flow, which is to be sent to a mobile communication device; and
a controller, determining a radio state of the mobile communication device when the incoming data packet of the traffic flow is received, determining whether the traffic flow is desirable or undesirable according to the radio state, and blocking or deferring the incoming data packet of the undesirable traffic flow when the traffic flow is determined to be undesirable, or prioritizing or not blocking the incoming data packet of the traffic flow when the traffic flow is determined to be desirable.

16. The traffic node of claim 15, wherein the controller further determines the traffic flow to be undesirable when the radio state indicates that the mobile communication device operates in an energy-saving state, or that the mobile communication device is about to switch from operating in a non-energy-saving state to operating in the energy-saving state.

17. The traffic node of claim 16, wherein the controller further determines the traffic flow to be desirable when the radio state indicates that the mobile communication device operates in the non-energy-saving state, or that the mobile communication device is about to switch from operating in the energy-saving state to operating in the non-energy-saving state.

18. The traffic node of claim 17, wherein the energy-saving state is one of the following:
an RRC (Radio Resource Control)_IDLE state;
a DRX (Discontinuous Reception)_OFF state;
an ECM (EPS (Evolved Packet System) Connection Management)_IDLE state; and
an MME (Mobility Management Entity)_DEREGISTERED state.

19. The traffic node of claim 17, wherein the non-energy-saving state is one of the following:
an RRC_CONNECTED state;
a DRX_ON state;
an ECM_CONNECTED state; and
an MME_REGISTERED state.

20. The traffic node of claim 15, wherein the controller further determines whether there is an outgoing data packet of the traffic flow being received from the mobile communication device within a time duration before or after the incoming data packet is received, and determines the traffic flow to be desirable when there is an outgoing data packet of the traffic flow being received from the mobile communication device within the time duration before or after the incoming data packet is received.

21. A traffic classification method executed by a traffic node of a service network, comprising:
determining a radio state of a mobile communication device when receiving an incoming data packet of the traffic flow, which is to be sent to the mobile communication device;
determining whether the traffic flow is desirable or undesirable according to the radio state; and
blocking or deferring the incoming data packet of the undesirable traffic flow when the traffic flow is determined to be undesirable, or prioritizing or not blocking the incoming data packet of the traffic flow when the traffic flow is determined to be desirable.

22. The traffic classification method of claim 21, further comprising:
determining the traffic flow to be undesirable when the radio state indicates that the mobile communication device operates in an energy-saving state, or that the mobile communication device is about to switch from operating in a non-energy-saving state to operating in the energy-saving state.

23. The traffic classification method of claim 22, further comprising:
determining the traffic flow to be desirable when the radio state indicates that the mobile communication device operates in the non-energy-saving state, or that the mobile communication device is about to switch from operating in the energy-saving state to operating in the non-energy-saving state.

24. The traffic classification method of claim 23, wherein the energy-saving state is one of the following:
an RRC (Radio Resource Control)_IDLE state;
a DRX (Discontinuous Reception)_OFF state;
an ECM (EPS (Evolved Packet System) Connection Management)_IDLE state; and
an MME (Mobility Management Entity)_DEREGISTERED state.

25. The traffic classification method of claim 23, wherein the non-energy-saving state is one of the following:
an RRC_CONNECTED state;
a DRX_ON state;
an ECM_CONNECTED state; and
an MME_REGISTERED state.

26. The traffic classification method of claim 21, further comprising:
determining whether there is an outgoing data packet of the traffic flow being received from the mobile communication device within a time duration before or after the incoming data packet is received; and
determining the traffic flow to be desirable when there is an outgoing data packet of the traffic flow being received from the mobile communication device within the time duration before or after the incoming data packet is received.
